(19) United States
(12) Patent Application Publication
(10) Pub. No.: US 2020/0097882 A1
(43) Pub. Date: Mar. 26, 2020

(54) MONITORING SYSTEM FOR EMPLOYMENT POSTINGS AND APPLICATIONS AND OTHER TRANSACTIONS

(71) Applicant: Meyyappan Alagappan, Fremont, CA (US)

(72) Inventor: Meyyappan Alagappan, Fremont, CA (US)

(21) Appl. No.: 16/139,841

(22) Filed: Sep. 24, 2018

(51) Int. Cl. G06Q 10/06; G06Q 50/16; G06F 17/24

(52) U.S. Cl. CPC G06Q 10/063112; G06F 17/243; G06Q 50/16

(57) ABSTRACT

In various implementations, job postings and applications for employment may be monitored. Job postings may include timelines, which have criteria that the employer and/or applicant for a job must satisfy during the application process. Ledger(s) may be generated based on timeline and associated with application(s) received and/or user(s). The ledgers may facilitate transparency and accountability in the application process for applicants and/or employers.

### TECHNICAL FIELD

The present invention relates to monitoring employment postings and applications.

### BACKGROUND

Currently, the process in which employers recruit and hire potential employees lacks transparency and fails to hold parties accountable for their actions. Employers may struggle to seek out qualified potential employees among job seekers, who may flood potential employers with resumes for jobs for which they are not qualified or may not have even carefully reviewed. Job Seekers may face postings from employers that do not intend to hire and lack of transparency in time frames and responses. For example, many job seekers have reported that it is common to not receive a rejection even after the potential employer has decided against the job seeker. Thus, there is a need for a system that creates transparency in the recruiting process and provides accountability to the various actors in the process.

### SUMMARY

In various implementations, a recruitment system is provided that allows various parties, such as employers, job seekers, and/or other related parties to register and interact. The recruitment system may generate a ledger at least partially viewable by one or more of the parties to facilitate transparency and accountability in the interactions between one or more parties.

In various implementations, employment applications may be managed and/or transactions between individuals may be monitored to facilitate transparency, fairness, and/or accountability between the parties. Job posting may be received from a plurality of employers. A job positing may be associated with an employer and may be received via a generated first graphical user interface. Timeline(s) associated with the job posting may be received and one of the plurality of employers may be associated with the job posting. Application(s) may be received from user(s) for one or more of the job postings. An application may be associated with one of the job postings by the system. Deposit(s) may be received from the user and/or the employer associated with the job posting. The deposit(s) may be associated with the job posting. The deposits may bring accountability to the process/transaction between the parties since each party may act according to the timeline (e.g., which may be known to parties) to retain their deposit(s). Ledger(s) may be generated based on one or more of the received applications and based on the timeline associated with the associated job posting. A ledger may be associated with the user and the employer associated with the job posting. A ledger may track each received application based on the timeline (e.g., the criteria provided in the timeline) associated with the associated job posting. The ledger(s) may be presented to the user and/or employer (e.g., associated with the ledger) via second graphical user interface(s). A determination may be made whether at least one of the employers did not satisfy at least a portion of one of the timelines in at least one of the ledgers; and, at least a portion of the deposit may be transferred to the user if a determination is made that at least one of the employers did not satisfy at least a portion of one of the timelines in the ledger(s). A determination may be made whether the user did not satisfy at least a portion of one of the timelines in at least one of the ledgers; and, at least a portion of the deposit may be transferred to one of the employers associated with the timeline if a determination is made that the user did not satisfy at least a portion of the timeline(s) in the ledger(s).

Implementations may include one or more of the following features. A determination may be made whether at least one of the employers satisfied at least a portion of one of the timelines in at least one of the ledgers; and, at least a portion of the deposit may be inhibited form being transferred to the user if a determination is made that at least one of the employers did satisfied at least a portion of the timeline(s) in the ledger(s). A determination may be made whether the user satisfied at least a portion of the timeline(s) in the ledger(s); and, at least a portion of the deposit may be inhibited from being transferred to one of the employers associated with the timeline if a determination is made that the user satisfied at least a portion of the timeline(s) in the ledger(s). The user may include a job seeker and/or a recruiter. The user may include a recruiter and the ledger may to be presented to the recruiter via a third graphical user interface. The third graphical user interface may present more than one ledgers (e.g., at least one of the presented ledgers is associated an additional user). The deposit may include money and/or points. The ledger may be presented to the employer via a third graphical user interface. The third graphical user interface presented to the employer may present more than one ledger, such as a ledger associated an additional user. The timeline and/or information received from the user and/or the employer(s) may be monitored. Ledger(s) may be updated based on the monitoring of the timeline(s) and the information received. The information received may include information from the employer(s) regarding the status of one of the applications. The information received may include additional information (e.g., answers to questionnaires, answers to requests from employers for additional information, etc.) to associate with the application from the user. At least one of the job postings may be updated based on information received from one of the employers associated with the at least one of the job postings. In some implementations, a request may be received from at least one of the employers to remove at least one of the job postings, and a determination may be made whether ledger(s) have been generated for the job posting(s). If ledger(s) have been generated, a determination may be made regarding whether the received requests satisfies the one or more timelines in the one or more ledgers associated with the job postings that have been requested to be removed. By monitoring job postings that have been requested to be removed, the system may inhibit employers from removing job postings as a way to avoid penalties from not satisfying timelines. At least a portion of the deposit may be transferred to the user if a determination is made that the request (e.g., to remove the job posting causes and/or does not satisfy the one or more timelines associated with the job posting). Transfer of at least a portion of the deposit to the user may be inhibited if a determination is made that the request does satisfy the one or more timelines. A rate at which the user did not satisfy at least a portion of one of the timelines in at least one of the ledgers may be monitored and/or the user may be inhibited from submitting one or more additional applications if the rate is greater than a predetermined rate. A rate at which the employer did not satisfy at least a portion of one of the timelines in at least one of the ledgers may be monitored and/or the employer may be inhibited from submitting one or more additional job postings if the rate is greater than a predetermined rate. The timeline may be based at least partially on a questionnaire provided by at least one of the employers and associated with the job posting. Determining whether the user did not satisfy at least a portion of one of the timelines may be based on one or more answers provided by a user to the questionnaire. In some implementations, a user may retain the deposit (e.g., the deposit may be retained in an account of the user and/or refunded to the user) if the user satisfies the timeline.

In various implementations, ledger(s) may be generated in response to receiving an application for a job posting from a user. Generating a ledger may include identifying the job posting and the employer associated with the application from a listing of a plurality of job postings that are associated with a plurality of employers. Timeline (e.g., criteria such as questionnaires answer requirements and/or time frames for responses selected by the employer) associated with the job posting may be determined. For example a timeline may be associated with a job posting and the time line may be retrieved and the ledger may be generated based on the retrieved timeline. The timeline may be previously received from the associated employer and associated with the job posting. The ledger may be updated based on information received from the user and/or the associated employer. The ledger may be presented to the user and/or the associated employer via second graphical user interface(s); A determination may be made whether one or more portions of the timeline is satisfied based on the information received. Notifications may be transmitted (e.g., to users such as an applicant, recruiter, and/or employer) if one or more of the portions of the timeline are not satisfied. Receiving information may include monitoring one or more interactions between the user and the employer to determine information. In some implementations, at least a portion of the deposit may be transferred to the user if a determination is made that the associated employer did not satisfy one or more of the portions of the timeline and/or at least a portion of the deposit may be transferred to the associated employer if a determination is made that the user did not satisfy one or more of the portions the timeline.

In various implementations, the described systems and processes may be utilized in managing, monitoring, promoting transparency, increasing accountability, etc. in other transactions. For example, a transaction posting of a first transaction may be received (e.g., by the system) from a first user. The transaction positing may be associated with the first user. The transaction posting may be received via a generated first graphical user interface. When receiving the transaction posting, a timeline associated with the transaction posting may be received. The timeline may include criteria related to the transaction. The first user may be associated with the transaction posting. An identification of at least one second user to the first transaction may be received (e.g., from second user(s), first users, and/or other users). At least one deposit may be received from the first user and/or the second user associated with the transaction posting. At least one ledger may be generated based on the transaction posting, the identification of the second user, the associated first user, and/or based on the timeline associated with the associated transaction posting. The ledger(s) may be associated with the first user and the second user(s). A ledger may allow tracking of the first transaction based on the timeline associated with the associated transaction posting. The ledger(s) may be presented to the first user and/or the second user(s) via second graphical user interface(s). A determination may be made whether the first user did not satisfy at least a portion of the timeline in at least one of the ledgers. At least a portion of the deposit(s) may be transferred to at least one of the second users if a determination is made that the first user did not satisfy the at least a portion of the timeline and if the at least one of the deposits is from the first user. A determination may be made whether at least one of the second users did not satisfy at least a portion of the timeline in at least one of the ledgers. At least a portion of at least one of the deposits may be transferred to the first user if a determination is made that the at least one of the second users did not satisfy at least a portion of the timeline and if the at least one of the deposits is from the at least one second user. In some implementations, a user may retain the deposit (e.g., the deposit may be retained in an account of the user and/or refunded to the user) if the user satisfies the timeline. In some implementations, more than one transaction posting may be received from the first user and at least one timeline may be received for the received transaction postings. At least one ledger may be generated for each of the received transaction postings. The transaction may include a real estate transaction, for example.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 illustrates an implementation of an example system to monitor transactions.

FIG. 2 illustrates an implementation of an example process to monitor transactions.

FIG. 3 illustrates an implementation of an example graphical user interface to facilitate receipt of job posting information.

FIG. 4 illustrates an implementation of an example graphical user interface to facilitate receipt of job posting information.

FIG. 5A illustrates an implementation of a graphical user interface that includes an example ledger.

FIG. 5B illustrates an implementation of a graphical user interface that includes an example ledger.

FIG. 5C illustrates an implementation of a graphical user interface that includes an example ledger.

Like reference symbols in the various drawings indicate like elements.

### DETAILED DESCRIPTION

In various implementations, transactions such as, but not limited to, seeking employment, real estate, and construction are at least partially closed. One party to the transaction may rely on the other party for updates and/or for information related to the transaction. For example, an employer may or may not update job seekers on the status of their application and/or if a job posting is removed or remains unfilled. As another example, an employer may not intend to hire immediately but merely collects resumes and not notify job seekers that a job posting is unavailable. Thus, a Ledger and Accountability (LA) System may be utilized to promote transparency, increase accountability of parties to the transaction, facilitate presentation of information to parties to the transaction, and/or increase party satisfaction with the transaction.

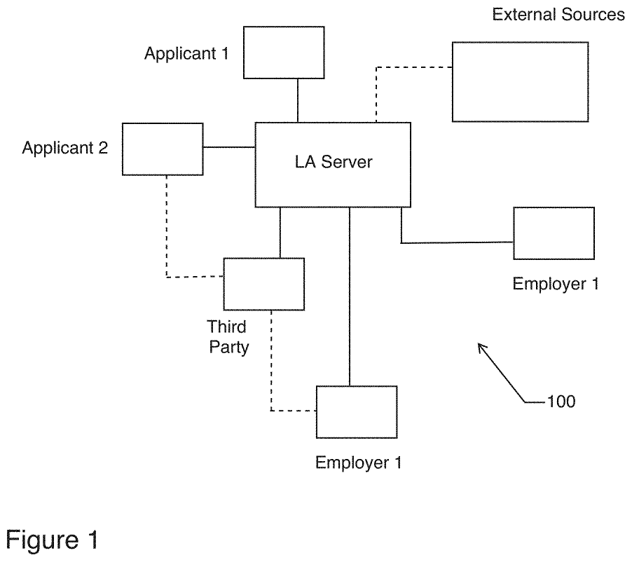

The LA System may include any computer, such as a web server, that is communicably coupled with users, such as job applicants and recruiters, and employers. FIG. 1 illustrates an implementation of an example LA System 100. The LA System may include a LA Server, such as a web server, that receives and processes information received from users such as of the LA System such as applicant(s), one or more third parties (e.g., recruiting agencies and/or individuals), and/or employer(s). The LA Server may store one or more modules that a processor can retrieve and utilize to perform various operations. The LA Server may (e.g., utilizing modules executed by the processor) generate interface(s) that facilitate interaction with, transmissions to, and/or receipt of information from various users. The users may access the LA Server via any appropriate network, such as but not limited to, the Internet. For example, the LA Server may be accessible via webpage(s). Users may utilize user devices (e.g., computers) such as mobile devices, tablets, and/or laptops to access the LA Server (e.g., web pages or other portions). The LA Server may be in communication with External Sources (e.g., to provide information about users and/or employers; to transfer money; to charge credit cards, etc.).

The LA Server may be utilized to manage transactions, such as transactions related to employment. For example, the LA Server may facilitate communication, transparency, and/or accountability among one or more applicants and one or more employers. The LA Server may manage a plurality of job postings and applications from one or more employers and one or more applicants. The LA Server may generate one or more graphical user interfaces communicate with employer(s), applicant(s), and/or third parties such as recruiter(s).

The LA System may or may not require users to register. For example, users may provide user information (e.g., user name, password, affiliated company, resume, payment information, etc.) to the LA System. The user information may be utilized to track users, provide users with ledger(s) associated the user information, etc.

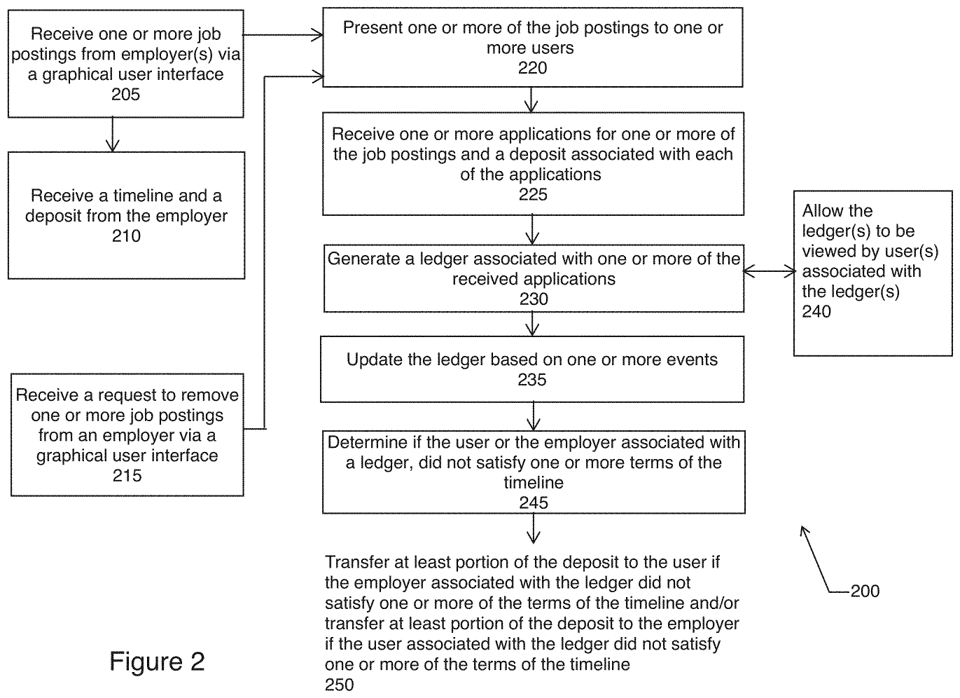

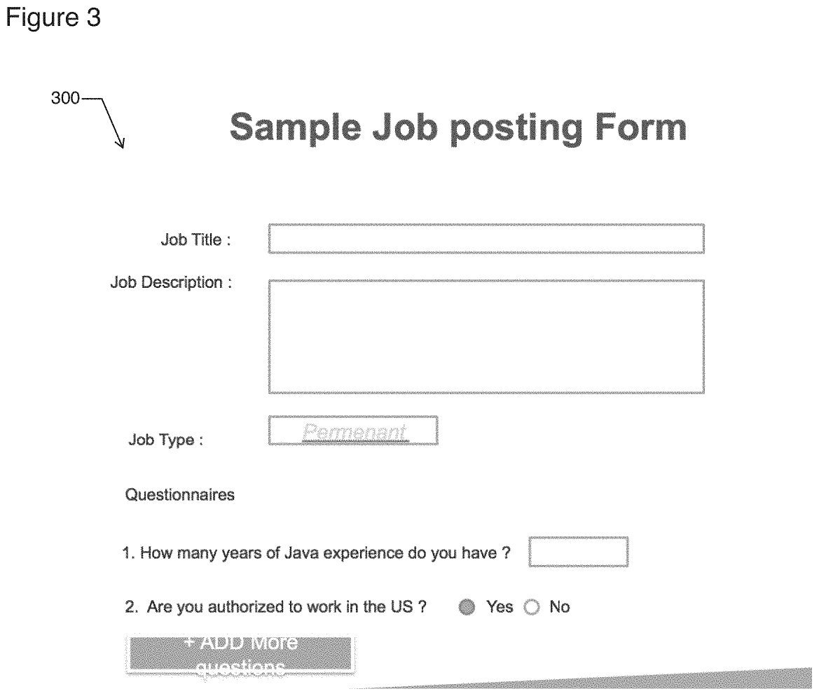

FIG. 2 illustrates an implementation of an example process 200 for managing employment postings and applications. One or more job postings may be received from employer(s) (operation 205). The LA System may generate a graphical user interface to facilitate receipt of a job posting. For example, the graphical user interface may include default values (e.g., experience level for a type of job description, based on LA System information, based on information provided by a user providing a post, etc.), include fields and/or other various appropriate tools to facilitate receipt of information from a user. A job posting may be associated with an employer. The job posting may include job information (e.g., title, salary, description, etc.), qualifications, and/or any other appropriate information. The job posting may include a job questionnaire (e.g., to which information is to be provided by an applicant). The job posting may or may not include the name of the employer. The LA Server may generate a graphical user interface to facilitate receipt of the job posting(s). FIG. 3 illustrates an implementation of an example graphical user interface 300 to facilitate receipt of information for a job posting. As illustrated, the LA Server may include fields (e.g., mandatory, optional, and/or customizable) on the graphical user interface through which information may be received. A job title, description, and/or type may be requested for a job posting. The graphical user interface may allow a questionnaire to be inserted, upload, and/or otherwise provided. The questionnaire may request information for evaluation by the employer with respect to the job posting, in some implementations. The graphical user interface(s) may include default values, fields from which to select among, etc. The graphical user interface may pre-fill information (e.g., for approval, disapproval, and/or change) based on information about the job (e.g., job title, type, description), employer information (e.g., user information) and/or past job postings provided by the employer. For example, the graphical user interface may include automatically and/or manually (e.g., a user may select questions from a listing of questions) include questions in a questionnaire, such as requesting credential information, certification information, experience, work authorization status, etc. As illustrated, the Questionnaire may allow entry of questions and/or fields to receive responses. The employer may be capable, in some implementations, of creating a job posting that requests any information from applicant(s) via the graphical user interface. In some implementations, the LA system may remove, flag, or otherwise mark requests for information that violates federal, state, and/or industry regulations. The job posting(s) and/or association(s) of the job posting(s) and employer(s) may be saved (e.g., in a memory of the LA System).

A timeline and a deposit may be received from employer(s) (operation 210). A timeline and a deposit may be associated with a received job posting, and thus associated with an employer. The timeline may include information such as criteria provided by the employer regarding the job posting. For example, the timeline may include, but is not limited to, criteria from a questionnaire (e.g., degree required, experience required, certification required, etc.), time frame(s) for responses from employer(s), which users are eligible to apply, deposit amount for application, terms to be satisfied for the deposit to be transferred (e.g., to the employer, applicant and/or third party), and/or any other appropriate criteria. The criteria may include rules, such as but not limited to rules by which interaction between users can be evaluated.

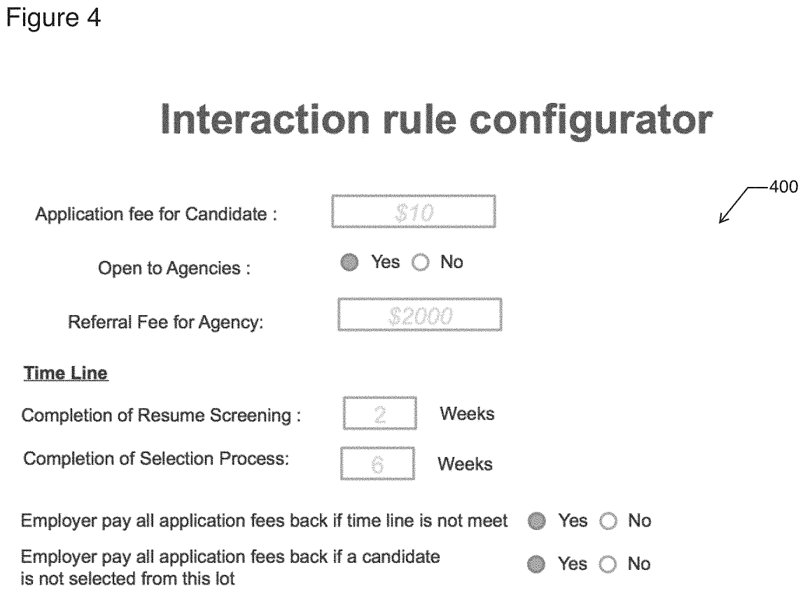

In some implementations, the LA system may generate a graphical user interface that facilitates creations of rules. FIG. 4 illustrates an implementation of an example graphical user interface 400 to facilitate generation of rules for a timeline. As illustrated, the graphical user interface 400 may request a first set of information related to the deposit such as application fee, who may apply (e.g., whether agencies such as recruiters or other users may apply for the opening on behalf of an applicant) and referral fees. The first set of information may include default values adjustable by employer(s). In some implementations, making the job posting open for applicants may be inhibited prior to receiving the first set of information or portions thereof. The graphical user interface 400 may request a second set of information related to evaluating the interactions between the users. The second set of information may or may not be optional. The second set of information may include time period criteria governing the interactions between the users (e.g., applicant will hear from employer in a predetermined period of time, applicant will provide information in a predetermined period of time, employer will screen by in predetermined period of time, employer will select applicant in a predetermined period of time, employer will interview applicant in a predetermined period of time, etc.). The graphical user interface 400 may request a third set of information related to the results of the evaluation of the interaction between users based on the second set of information. For example, the third set of information may be related to when, how much, and how deposits may be transferred between or returned to users. An employer may select via the graphical user interface that a deposit (e.g., application fee) may be returned if one or more of criteria based on the second set of information is not satisfied. Default values may be provided. As illustrated, the employer may select to return deposits from applicants (e.g., application fees) if time line is not met, if candidate is not selected, etc. The LA system may keep and/or distribute at least a portion of the deposit provided by the employer to the applicants if the employer does not satisfy criteria based on the first and/or second set of information, in some implementations. In some implementations, making the job posting open for applicants may be inhibited prior to receiving the first, second, and/or third set of information or portions thereof.

The LA system may collect job postings from one or more employers. The LA system may generate one or more graphical user interfaces that present job posting(s) to user(s) (operation 220). The graphical user interfaces may allow users to view, search, and/or track job postings. For example, a user may be capable of tracking jobs available by job title and/or employer. In some implementations, users may receive messages regarding job postings (e.g., for which the user has and/or has not applied based on criteria provided by the LA Server and/or user). For example, a user may be alerted when a user-selected company provides a job description that is similar to user information (e.g., the LA server may analyze job information and/or user information for compatibility and/or matches).

One or more applications and associated deposit(s) may be received for one or more job postings (operation 225). The deposits may be received from employers, recruiter, job applicants, and/or other users. The deposits may be received from third parties on behalf of a user. For example, a user may select (e.g., via a generated graphical user interface) one or more job postings to which the user would like to apply. The job posting may identify the deposit (e.g., application fee) associated with the job posting and the user may provide the deposit and/or allow the LA server to charge the deposit (e.g., to credit card, debit card, and/or gift card, via commercially available payment systems, etc.). The application may include one or more answers to the questionnaire requested by the employer. The user may provide transmit answers to the questions in the questionnaire via graphical user interfaces generated by the LA System. The application may be associated a user and with one or more job postings. The deposit may be associated with a user and a job posting (e.g., a user may provide a deposit that is shared or otherwise split among job postings). The application and/or user information may be transmitted to the employer for evaluation.

The LA System may generate a ledger associated with a received application (operation 230). In some implementations, a ledger may be associated with an application for job posting (e.g., associated job posting), an employer (e.g., associated with the associated job posting), and/or one or more other users (e.g., associated with the application such as job applicants and/or recruiters). The ledger may be associated with more than two users (e.g., employer, third party, and/or applicant), in some implementations. The ledger may include information such as application information (e.g., code associated with the application, information provided in response to a questionnaire from the employer, and/or other appropriate information). The ledger may include user information (e.g., job, scores, credit, etc.). The ledger may include an identity of an employer associated with the job posting for which the application is responsive.

The ledger may track the passage of time and/or interactions between users related to the application. The ledger may allow evaluation of the tracked information with the timeline associated with the associated job posting. For example, the timeline may include criteria related to the questionnaire. As another nonlimiting example, the timeline may include criteria such as predetermined times within which a user must take an action (e.g., provide job application, provide answers to questions in questionnaire, provide deposit, interview an applicant, hire an applicant, and/or any other appropriate action in the transaction).

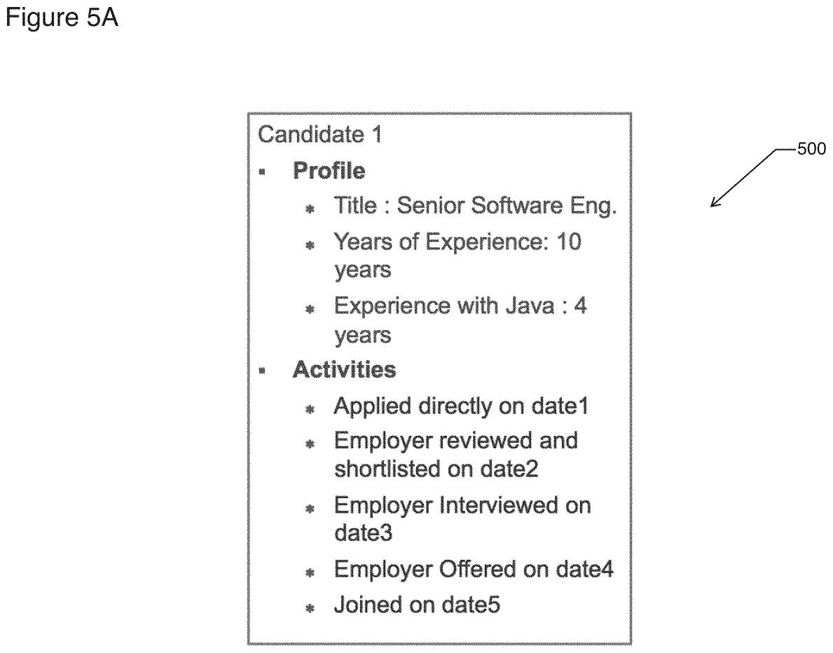

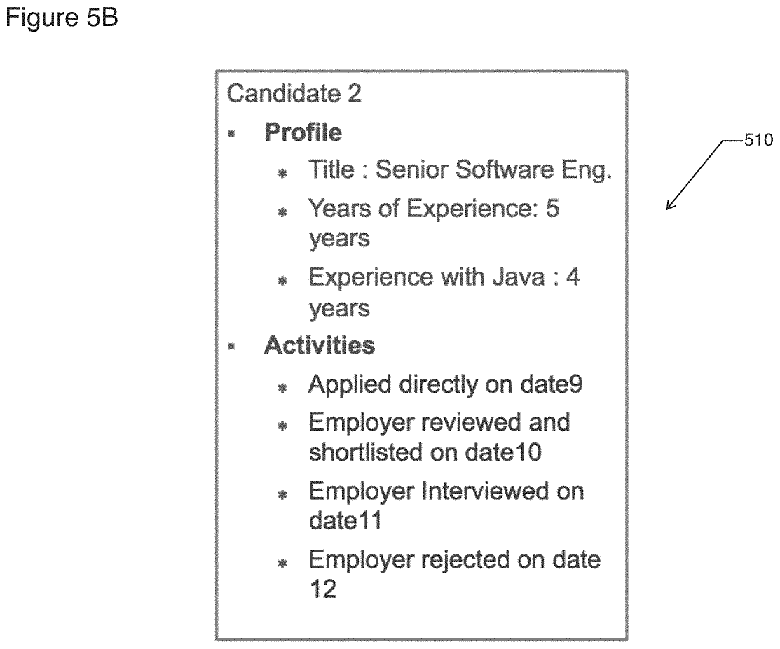

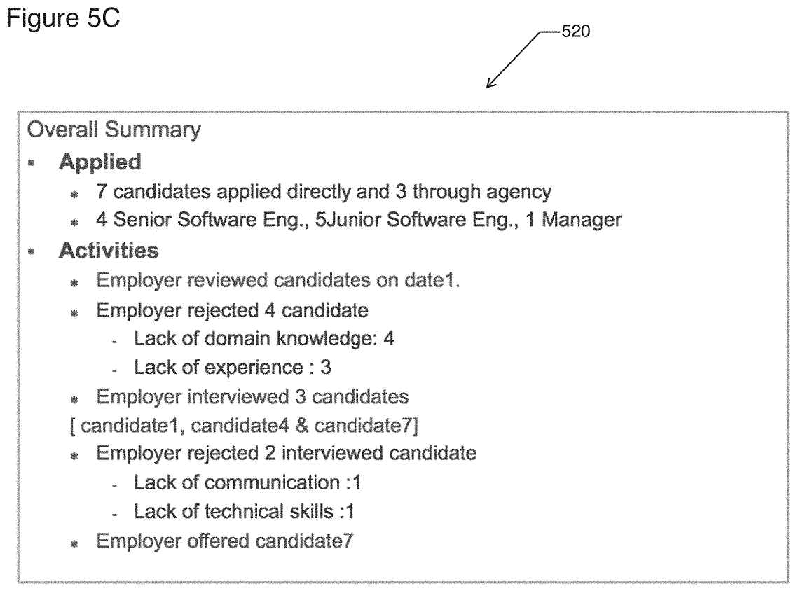

FIGS. 5A-5C illustrate implementations of example ledgers 500, 510, 520. As illustrated, ledger 500, in FIG. 5A, identifies the applicant, Candidate 1, and includes user information (e.g., title, years of experience, years of a subset of experience). As illustrated, ledger 510, in FIG. 5B, identifies the applicant, Candidate 2, and includes user information (e.g., title, years of experience, years of a subset of experience). The user information include may be based at least partially on answers provided to the questionnaire associated with the job posting for with which the application is associated. The ledger may include a listing of interactions between the users (e.g., activities). As illustrated, the ledger may include application date, one or more status indications (e.g., whether the employer has reviewed the application, selected the application, interviewed the applicant, offered a job to the applicant, whether the applicant has accepted, whether the recruiter was contacted, receipt of deposit, transfer of deposit, etc.), and date(s) associated with the status indications (e.g., date on which the application was received and/or reviewed). The ledger may include criteria by which answers to the questionnaire associated with a job posting may be judged.

The ledger presented to a user may depend on the type of user. For example, a user that is an applicant may be presented a ledger associated with application submitted by the user for a job posting, such as the example ledgers illustrated in FIGS. 5A-5B. The ledger may or may not include applications submitted by the applicant to more than one job posting. Access to a ledger may be restricted, in some implementations. A user may be inhibited from viewing the ledger of one or more other users. For example, a user that is an applicant may be inhibited from viewing the ledger of other users, such as other applicants to the same or different job postings, a recruiter associated with the ledger, and/or an employer associated with the same or different job posting. In some implementations, a recruiter may be capable of accessing ledgers associated with users (e.g., applicants) associated with the recruiter. A recruiter, for example working on behalf of a company, may be capable of reviewing (e.g., being presented) ledgers associated with different applicants but associated with job posting(s) for this same company. An employer may be capable of viewing the ledgers associated with a job posting generated by the employer or a recruiter, for example, which generated the job posting on behalf of the company. FIG. 5C illustrates an implementation of an example graphical user interface 520 generated by the LA System for an employer. As illustrated, the interface 520 may include summary information such as number of applicants, type of applicant (e.g., direct user, from a third party on behalf of an applicant, etc.), and/or any other appropriate information. The ledger may track and/or present interactions between the users. For example, the ledger may include status changes for applicants to a job posting of the employer and/or dates of status changes, criteria used for evaluation of the applicants, final result (e.g., hired, not hired, shortlisted, no qualified candidates presented, etc.).

The ledger may be presented to user(s) associated with the ledger(s) (operation 240). The ledger may be inhibited from being altered by users to which the ledger is presented. The ledger may track access and/or presentation of the ledger to users. Thus, accountability and transparency in the transaction may be increased since each user can view the timeline and/or progress in the timeline.

The ledger may be updated based on events (operation 235). For example, a user may report an event to the LA system (e.g., interviewed Candidate 7), and the ledger may be updated (e.g., for the candidate, employer, and/or other users such as other applicants and/or recruiters). In some implementations, communications between the users may be via the LA System and the LA System may automatically identify an event based on the communications (e.g., the communications may be monitored). Events may include activities that impact status (e.g., withdrawal of application, submission of application, receipt of deposit, lack of deposit, review of application, decline application, interview, job offered, job withdrawn, job declined, job accepted, etc.) and/or any other appropriate activity. The ledger may be amended but deletion and/or other removal of information may be inhibited, in some implementations.

The ledger may be analyzed, in some implementations. For example, the ledger may be analyzed to determine if the user and/or employer associated with a ledger satisfied or did not satisfy one or more terms of the timeline associated with a job posting and thus associated with the ledger. For example, the ledger may be analyzed for compliance with rules regarding interaction between users (e.g., activities recorded in the ledger may be analyzed based on the rules provided by the employer with the job posting associated with the application and ledger). The ledger may be analyzed for compliance with job requirements in a job posting (e.g., whether answers to questionnaire and/or a deposit have been provided). In some implementations, the LA System may evaluate the information provided by the user in response to the questionnaire and determine if the information provided satisfies, partially satisfies, or does not satisfy the timeline criteria related to the questionnaire. For example, the timeline may include criteria related to the questionnaire such as that the applicant must have MS Word experience. If the applicant provides a response that indicates that the applicant does not have MS Work experience, then the applicant has not satisfied the criteria. As another nonlimiting example, the timeline may include criteria such as that the employer must interview at least 2 applicants by a predetermined date in the timeline. If the employer interviews only 1 applicant by the predetermined date in the timeline, the employer has only partially satisfied the timeline. The analysis may be utilized by the LA System to perform further actions such as notifications provided to the user and/or transfers of the deposit.

At least a portion of the deposit may be transferred to the user if the employer associated with the ledger (e.g., via the job posting) did not satisfy one or more terms of the timeline and/or at least a portion of the deposit may be transferred to the employer if the user associated with the ledger did not satisfy one or more terms of the timeline. Thus, the employers and the employees may be held accountable for their actions in the job application and acceptance transaction. The accountability may inhibit and/or discourage employers from posting jobs for which they do not intend to hire individuals. The accountability may inhibit and/or discourage applicants from applying for jobs for which they are not qualified and/or do not intend to accept (e.g., rules criteria for interactions may indicate that a job offer must be declined within 1 week and a deposit such as an application fee, may be at least partially transferred to the employer if the applicant declines outside the window).

In some implementations, process 200 may be implemented by various systems, such as system 100 or portions thereof. In addition, various operations may be added, deleted, and/or modified. In some implementations, a process may be performed in combination with other processes or operations thereof. For example, the LA system may allow communication between users (e.g., applicants to the same or similar job postings, applicant(s) and employer(s), applicant(s) and recruiter(s), recruiter(s) and employer(s), and/or among any other appropriate users).

In some implementations, a user may register for an account prior to providing job postings, applications, deposits, etc. A user may provide user information (e.g., name, background, contact information, etc.) and/or deposit funding when registering. Contact information may be verified (e.g., automatically via the LA System and/or manually by individuals associated with the LA System). Deposit funding may be verified, in some implementations. The LA System may verify one or more pieces of information provided by the user, such as name, affiliated company, information on resumes, etc. The LA System may utilize tools such as web crawlers, interfaces with external sources of information, and/or transmission of notifications to external sources to verify information.

A user may change, add, or delete information provided with registration and/or thereafter to the LA System. A user may provide contact preferences such as when to automatically transmit messages to the user (e.g., upon job postings that satisfy user provided criteria, upon viewing of a public profile of a user, upon status change, upon noncompliance with timeline, etc.) and/or how a user would like to be contacted.

Users may be applicants, third parties such as recruiters, and/or employers. Recruiters may have privileges similar to applicants, such as the ability to submit and application to the LA System, search and/or review job postings, answering questionnaires on behalf of applicants, receive notifications (e.g., based on recruiter and/or other user provided criteria), etc. In some implementations, an additional deposit may be associated with third party users agency fee (e.g., based on job posting timeline, employer requirements, and/or LA System requirements). The additional deposit may be transferred if the third party does not comply with timeline or portions thereof. Thus, the additional deposit may inhibit and/or discourage third party users from submitting a plurality of applications without carefully reviewing the applications.

In some implementations, the LA System may inhibit and/or restrict applications from being received for job postings in which a timeline and/or deposit have not been provided. For example, if an employer fails to provide a timeline, then applicants may be inhibited from applying to the job posting and/or a message may be transmitted to the user (e.g., that the job posting does not provide a timeline, that applications are at the risk of the applicant, etc.). In some implementations, a rate of compliance with timelines in job postings may be determined for one or more users (e.g., employers, recruiters, and/or applicants). Actions may be allowed and/or inhibited based on the rate of compliance. For example, if an employers has rate of compliance that is lower than a predetermined minimum, the employer may be restricted from providing additional job positing, job postings may be removed from the LA servers listing of job postings, at least a portion of deposits associated with the employer may be transferred to the LA server and/or other users, etc. As another example, if a user such as a recruiter has rate of compliance that is lower than a predetermined minimum, the recruiter may be inhibited from providing additional job applications, inhibited from collecting transfers of deposits or portions thereof (e.g., referral fees), etc. As another example, if a user such as a job applicant has rate of compliance that is lower than a predetermined minimum, the job applicant may be inhibited (e.g., for a period of time) from providing additional job applications and/or inhibited from receiving transfers of deposits (e.g., to inhibit job applicants applying to a plurality of jobs seeking money due to lack of compliance by employers rather than seeking employment).

The LA server may inhibit applications received without deposits from being further processed (e.g., viewable by employers, satisfying criteria regarding interactions between users, etc.). In some implementations, users may receive a message (e.g., via graphical user interfaces of the LA system and/or other messages) when deposits are insufficient and/or not received.

In some implementations, the LA System may allow users (e.g., applicants and/or employers) to prepay and/or pay a predetermined number of deposits. For example, an applicant may register and/or pay for a predetermined number of deposits.

In some implementations, a deposit may be money, credit, and/or points. For example, a user may provide a deposit via credit card, cash, check, EFT, wire transfer, e-currency, etc. The user may have a credit for an amount (e.g., as a default, as a member of a group of users such as users receiving job training, members that are graduating from an educational institution, etc.). The deposit may be points based. For example, a user may have points based on reviews from past employers, credit check, background check, payment of money, etc. An employer may have points based on number of job postings, frequency of compliance with timeline, money submitted, frequency of use, etc. The point balance may be tracked by the LA System for each user and adjusted based on transferred (e.g., job applications submitted, timeline compliance, timeline noncompliance, etc.).

In some implementations, the transfer of deposits (e.g., upon noncompliance with a timeline or portion thereof) may be automatic. A notification of the noncompliance may be transmitted to the noncompliant user prior to transfer of a deposit in some implementations. An opportunity to correct a noncompliance may or may not be provided for noncompliance with a timeline or a subset thereof (e.g., predetermined types of noncompliance, predetermined portions of a timeline, etc.).

In some implementations, one or more of the parties to the transaction may not provide a deposit. One party may provide a deposit and another party may not. The transfer of the deposit upon noncompliance, thus, may be based on which party provides the deposit. For example, an employer may not provide a deposit while a user such as a job applicant and/or a recruiter may provide a deposit. The employer may not, thus, have a deposit against which transfers due to noncompliance can be registered. The system may provide notifications based on noncompliance and/or restrictions on the employer (e.g., inhibit addition of job posting, etc.).

In some implementations, an employer may provide a deposit after other users such as recruiters and/or applicants apply for a job posting in addition to and/or in place of a deposit associated with a job posting. The deposit provided upon application for the job posting may be treated in a similar fashion as the deposit associated with the job posting. For example, if the employer is in noncompliance with a timeline then at least a portion of the deposit may be transferred from the employer to a user.

In some implementations, a user may provide a bulk deposit and/or a deposit good for multiple transactions.

In some implementations, a portion of the deposit (e.g., from users such as employer, recruiter and/or applicant) may be transmitted to the system. For example, for facilitating transactions, a portion of the deposit may be transmitted to and/or retained by the system (e.g., accounts associated with the system). In some implementations, the LA system may retain (e.g., keep as a profit, cost of operation, etc.) at least a portion of the deposit from a user and/or employer. If an employer does not satisfy at least a portion of a timeline in at least one of the ledgers, at least a portion of the deposit from the employer may be retained (e.g., by the LA System). For example, a portion of the deposit may be retained (e.g., by the LA System) and a portion may be transferred to user(s). If a user, such as an applicant, does not satisfy at least a portion of a timeline in at least one of the ledgers, at least a portion of the deposit from the user may be retained (e.g., by the LA System). For example, a portion of the deposit may be retained (e.g., by the LA System) and a portion may be transferred to an employer, to which a ledger is associated and/or a portion may be transferred to a user(s), such as recruiter(s) and/or agencies paying for access to the LA System (e.g., job training programs, government programs, etc.). If a user, such as a recruiter, does not satisfy at least a portion of a timeline in at least one of the ledgers, at least a portion of the deposit from the user may be retained (e.g., by the LA System). For example, a portion of the deposit may be retained (e.g., by the LA System) and a portion may be transferred to an employer, to which a ledger is associated and/or a portion may be transferred to a user(s), such as a job applicant.

The ledger may be stored in a memory of the LA System, the memory of user devices, and/or combinations thereof. A ledger may utilize block chain protocol to store and/or maintain the integrity of the ledger. In some implementations, the LA System may store the ledger in a memory of the LA System.

In some implementations, a ledger may be associated with a user and more than one application for a job posting may be included on the ledger. A user may access ledger(s) associated with the user (e.g., the ledger may be presented to the user via the LA System).

A ledger may be associated with an employer and/or a job posting of an employer and more than one application for a job posting may be included on the ledger, in some implementations.

A ledger may be associated with a user, such as a recruiter, and the ledger may track more than one applicant associated with the user for a job posting. The ledger may allow a recruiter to track more than one application associated with an applicant associated with the user. In some implementations, compliance with portions of the timeline may cause the system to transfer a portion of one of the deposits to the recruiter. For example, if an applicant associated with the recruiter is given a job and/or interview, a portion of the deposit may be transferred from the deposit from employer and/or the applicant to the recruiter. In some implementations, a user may employ a recruiter, who is only paid if the applicant reaches a predetermined stage (e.g., the timeline of a ledger between the applicant and the employer and/or recruiter may track and monitor). For example, if an applicant associated with the recruiter is given an interview with an employer, a portion of the deposit may be transferred from the deposit from the applicant to the recruiter.

A ledger may be updated based on monitoring by the LA System (e.g., monitoring messages via the LA System between users). A ledger may be updated based on information provided by users to the LA. The information may be provided by one party to the transaction and may not be provided by one or more other parties to the transaction, in some implementations. For example, employer(s) may provide information to the LA System to identify events. In some implementations, a ledger may be updated based on information provided by parties associated with the ledger (e.g., job offer transmitted and/or job offer received). In some implementations, parties not associated with the ledger may provide information to identify events (e.g., a job offer may be reported by one user and the ledger of another user may be updated based on the job offer to another user).

In some implementations, the LA System may utilize External Sources to manage deposits. For example, the LA System may utilize existing payment platforms such as PayPal to facilitate management of deposits. The LA System may collect, receive, refund, retain, and/or transfer deposits or portions thereof. The LA System may utilize one or more payment platforms to facilitate the management of these operations, for example. For example, the LA System may communicate with and/or include interfaces that communicate with payment platforms to receive deposits, refund deposits or portions thereof, and/or transfer deposits or portions thereof.

In some implementations, the LA Server may interact with and/or interface with employer hiring software platforms, such as Taleo (Dublin, Calif.). For example, an interface may allow the LA Server to directly receive information from an employer software platform rather than or in addition to receiving information via generated graphical user interfaces.

The LA Server may be embedded and/or at least partially embedded in a website of a user. For example, the LA System may be at least partially embedded in a website associated with the recruiter such that applicants and/or employers access the LA System via the website associated with the recruiter. As another example, the LA System may be at least partially embedded in a website associated with an employer such that applicants access the LA System via the website associated with the employer.

In some implementations, the described system and processes or portions thereof may be utilized in conjunction with a state, federal, educational (e.g., university, school district), and/or corporate employment program such as worker's compensation, job retraining, etc. The deposits may be provided at least partially by the employment program, in some implementations. The employment program may be capable of accessing the ledger to ensure compliance with regulations and/or laws of the employment program and/or the system may monitor users to facilitate compliance with regulations and/or laws (e.g., apply for a predetermined number of jobs a week, tracking job applicant responsiveness to employers, etc.). In some implementations, if the user satisfies a timeline or portion thereof, a portion of the deposit from the employment program (e.g., state, federal, educational such as university, school district, and/or corporate employment program such as worker's compensation, job retraining, etc) may be transferred to the user. For example, a portion of a worker's benefit (e.g., job retraining, unemployment benefit, etc.) may be provided as a deposit to the LA System and at least a portion of the deposit may be transferred to the user upon satisfaction of the timeline. The LA system may retain at least a portion of the deposit provided by the employment program, in some implementations.

Although the described systems and processes have been described in terms of facilitating recruitment, the one or more of the operations of the described systems and processes may be utilized in other areas. For example, the described systems and processes may be utilized to facilitate real estate transactions. Similarly to recruitment for employment, the real estate process has been described as lacking transparency. In residential real estate, seller may complain about buyers that walk away and buyers may complain about lack of transparency in competing offers. Thus, the described ledger may be utilized with real estate transactions.

As another example, ledgers may be utilized in construction. The ledger may be utilized in one or more phases, such as requests for bids, bid selection, design phase, and/or construction phase (such as for the management of requests for information). The ledger may provide transparency as to other bids in competition (e.g., 3 other bids have been provided), phase of bid selection, and/or other appropriate information. The ledger may clearly provide timelines and incentives and/or penalties for compliance and/or lack of compliance with timelines in the ledger.

As another example, ledgers may be utilized to increase transparency in requests for bids in construction and corporate vendor selection.

The described systems and processes may be utilized in managing, monitoring, promoting transparency, increasing accountability, in transactions. For example, a transaction posting of a first transaction may be received (e.g., by the system). The transaction posting may be received from a first user. The first user may be a party to the transaction. In some implementations, the transaction posting may be provided by third party users such as title companies, law firms, general contractors, etc. The transaction positing may be associated with parties to the transaction, such as the first user. The transaction posting may be received via a generated first graphical user interface. The first graphical user interface may allow transaction details associated with the first transaction to be provided (e.g., uploaded, transmitted to the LA Server, provided in fields, etc.). When receiving the transaction posting, a timeline associated with the transaction posting may be received. The timeline may include criteria related to the transaction (e.g., criteria to be satisfied by one or more parties such as milestones in the transaction, qualifications of the parties such as funding requirements, and/or any other appropriate criteria). The first user may be associated with the transaction posting. An identification of at least one second user to the first transaction may be received (e.g., from second user(s), first users, and/or other users). At least one deposit may be received from the first user and/or the second user associated with the transaction posting. At least one ledger may be generated based on the transaction posting, the identification of the second user, the associated first user, and/or based on the timeline associated with the associated transaction posting. The ledger(s) may be associated with the first user and the second user(s). The ledger may increase accountability and transparency of the transaction. A ledger may allow tracking of the first transaction based on the timeline associated with the associated transaction posting. The timeline may be evaluated by the LA System in view of information provided by the users (e.g., milestones, qualifications, etc.). The ledger(s) may be presented to the first user and/or the second user(s) via second graphical user interface(s). A determination may be made whether the first user did not satisfy at least a portion of the timeline in at least one of the ledgers. At least a portion of the deposit(s) may be transferred to at least one of the second users if a determination is made that the first user did not satisfy the at least a portion of the timeline and if the at least one of the deposits is from the first user. A determination may be made whether at least one of the second users did not satisfy at least a portion of the timeline in at least one of the ledgers. At least a portion of at least one of the deposits may be transferred to the first user if a determination is made that the at least one of the second users did not satisfy at least a portion of the timeline and if the at least one of the deposits is from the at least one second user. In some implementations, a user may retain the deposit (e.g., the deposit may be retained in an account of the user and/or refunded to the user) if the user satisfies the timeline. In some implementations, more than one transaction posting may be received from the first user and at least one timeline may be received for the received transaction postings. At least one ledger may be generated for each of the received transaction postings. The transaction may include a real estate transaction, for example.

In some implementations, the LA Server may include applications that reside on one or more servers (e.g., web servers and/or virtual servers). In some implementations, the LA Server may at least partially reside on user devices via applications. The applications on user devices may perform one or more of the described operations independently or in communication with the application(s) on the LA Server. The LA Server may store information (e.g., job postings, applications, timelines, user information, ledgers, etc.) on a memory of the LA Server and/or a memory accessible by the LA Server (e.g., using block chain protocol, on a remote repository, etc.).

In some implementations, the LA System may utilize External Sources such as repositories, reporting agencies, and/or any other appropriate external source. For example, the LA system may communicate with a credit agency to determine a user's credit rating. The credit rating may be provided to an employer as part of an application, in some implementations. The LA System may verify one or more portions of an application in some implementations. The LA System may communicate (e.g., via interfaces and/or via messages) with verification agencies, past employers, educational institutions, etc. to verify one or more portions of a resume. For example, the LA Server may generate messages (e.g., emails or other communications) and transmit the messages to external sources to verify one or more portions of a resume associated with an application. As another example, the LA Server may transmit a cover letter, exemplary work, and/or essay, to an external source for plagiarism detection and/or evaluation (e.g., strength of writing, errors, etc.)

Although a specific system has been described in FIG. 1, the system may include any appropriate computer(s) (e.g., personal computers such as laptops, tablets, and/or mobile phones; servers, etc.), or other programmable logic device in any appropriate arrangement. The computer(s) of the system (e.g., individually and/or in conjunction with other computers in the system) may include a processor that executes instructions (e.g., modules) and manipulates data to perform operations of the system. Processor may include a programmable logic device, a microprocessor, or any other appropriate device for manipulating information in a logical manner and memory may include any appropriate form(s) of volatile and/or nonvolatile memory, such as RAM and/or Flash memory.

In addition, various software may be stored on the memory. For example, instructions such as operating systems, other types of software, and/or module(s) to perform operations of the system may be stored on the memory.

In some implementations, modules may be combined, such as into a single module or multiple modules. Operation modules may include various modules and/or sub-modules.

A communication interface may allow a computer of the system to communicate with other components of the system, other repositories, and/or other computer systems. The communication interface may transmit data from the computer and/or receive data from other components, other repositories, and/or other computer systems via network protocols (e.g., TCP/IP, Bluetooth, and/or Wi-Fi) and/or a bus (e.g., serial, parallel, USB, and/or FireWire). Operations of the system stored in the memory may be updated and/or altered through the communication via network protocols (e.g., remotely through a firmware update and/or by a device directly coupled to the computer).

Although one example system has been disclosed, which includes computers, which may be used with the disclosure, the system can be implemented through computers such as servers, as well as a server pool. For example, controller may include a general-purpose personal computer, a workstation, a UNIX-based computer, a server computer such as a web server, any other suitable device, or combinations thereof.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system, including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable signal(s) may be non-transitory waves and/or non-transitory signals.

Although users have been described as a human, a user may be a person, a group of people, a person or persons interacting with one or more computers, and/or a computer system.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a ledger” includes a combination of two or more ledgers and reference to “a deposit” includes different types and/or combinations of deposits. For example, a deposit many include money, credit, and/or points.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A computerized method of monitoring employment applications, the method comprising:
receiving one or more job postings from a plurality of employers, where a job positing is associated with an employer, wherein the one or more job postings are received via a generated first graphical user interface, and wherein receiving one of the job postings comprises;
receiving a timeline associated with the job posting;
associating one of the plurality of employers with the job posting;
receiving one or more applications, from a user, for one or more of the job postings, wherein each application is associated with one of the job postings;
receiving a deposit from at least one of the user or the employer associated with the job posting;
generating at least one ledger based on one or more of the received applications and based on the timeline associated with the associated job posting; and wherein the at least one ledger is associated with the user; and wherein each ledger tracks each received application based on the timeline associated with the associated job posting;
allowing the ledger to be presented to the user via a second graphical user interface;
determining whether at least one of the employers did not satisfy at least a portion of one of the timelines in at least one of the ledgers;
transferring at least a portion of the deposit to the user if a determination is made that the at least one of the employers did not satisfy at least a portion of one of the timelines in at least one of the ledgers;
determining whether the user did not satisfy at least a portion of one of the timelines in at least one of the ledgers;
transferring at least a portion of the deposit to one of the employers associated with the timeline if a determination is made that the user did not satisfy at least a portion of one of the timelines in at least one of the ledgers;
retaining at least a portion of the deposit from the user if a determination is made that the user did not satisfy at least a portion of one of the timelines in at least one of the ledgers; and
retaining at least a portion of the deposit from the employer if a determination is made that the at least one of the employers did not satisfy at least a portion of one of the timelines in at least one of the ledgers.

2. The method of claim 1 wherein the user comprises at least one of a job seeker or a recruiter.

3. The method of claim 1, wherein the user comprises a recruiter; and further comprising allowing the ledger to be presented to the recruiter via a third graphical user interface, wherein the third graphical user interface presents more than one ledgers, wherein at least one of the presented ledgers is associated an additional user.

4. The method of claim 1 wherein the deposit comprises at least one of money or points.

5. The method of claim 1 further comprising allowing the ledger to be presented to the employer via a third graphical user interface.

6. The method of claim 5 wherein the third graphical user interface presents more than one ledgers, wherein at least one of the presented ledgers is associated an additional user.

7. The method of claim 1 further comprising:
monitoring the timeline and information received from at least one of the user and one or more of the employers; and
updating the ledger based on the monitoring of the timeline and the information received.

8. The method of claim 7 wherein the information received comprises information from at least one of the employers regarding the status of one of the applications.

9. The method of claim 7 wherein the information received comprises additional information to associate with the application from the user.

10. The method of claim 1 further comprising updating at least a portion of at least one of the job postings based on information received from one of the employers associated with the at least one of the job postings.

11. The method of claim 1 further comprising:
receiving a request from at least one of the employers to remove at least one of the job postings;
determining if one or more ledgers have been generated for the at least one of the job postings;
if one or more ledgers have been generated, determining the received requests satisfies the one or more timelines in the one or more ledgers associated with the at least one of the job postings;
transferring at least a portion of the deposit to the user if a determination is made that the request does not satisfy the one or more timelines;
inhibiting transfer of at least a portion of the deposit to the user if a determination is made that the request does satisfy the one or more timelines.

12. The method of claim 1 further comprising monitoring a rate in which the user did not satisfy at least a portion of one of the timelines in at least one of the ledgers; and inhibiting the user from submitting one or more additional applications if the rate is greater than a predetermined rate.

13. The method of claim 1 further comprising monitoring a rate in which at least one of the employers did not satisfy at least a portion of one of the timelines in at least one of the ledgers; and inhibiting the at least one employer from submitted one or more additional job postings if the rate is greater than a predetermined rate.

14. The method of claim 1 wherein the timeline is based at least partially on a questionnaire provided by at least one of the employers and associated with the job posting; and wherein determining whether the user did not satisfy at least a portion of one of the timelines is based on one or more answers provided by a user to the questionnaire.

15. An article comprising non-transitory, machine-readable medium storing instructions to monitor employment applications, the instructions operable to cause data processing apparatus to perform operations comprising:
generating one or more ledgers in response to receiving an application for a job posting from a user; wherein generating each ledger comprises:
identifying the job posting and the employer associated with the application from a listing of a plurality of job postings that are associated with a plurality of employers;
determining the timeline associated with the job posting, wherein the timeline was previously received from the associated employer and associated with the job posting;
allowing the ledger to be updated based on information received from at least one of the user or the associated employer;
allowing the ledger to be presented to at least one of the user or the associated employer via a second graphical user interface;
determining if one or more portions of the timeline is satisfied based on the information received;
transmitting one or more notifications if one or more of the portions of the timeline is not satisfied.

16. The article of claim 15 wherein receiving information comprises monitoring one or more interactions between the user and the employer to determine information.

17. The article of claim 15 wherein the instructions are further operable to cause data processing apparatus to perform operations comprising:
transferring at least a portion of the deposit to the user if a determination is made that the associated employer did not satisfy one or more of the portions of the timeline; and
transferring at least a portion of the deposit to the associated employer if a determination is made that the user did not satisfy one or more of the portions the timeline.

18. A computerized method of monitoring a transaction between one or more parties, the method comprising:
receiving transaction posting of a first transaction from a first user, where the transaction positing is associated with the first user, wherein the transaction posting is received via a generated first graphical user interface, and wherein receiving the transaction posting comprises;
receiving a timeline associated with the transaction posting, and wherein the timeline comprises criteria related to the transaction;
associating the first user with the transaction posting;
receiving an identification of at least one second user to the first transaction, from the at least one second user;
receiving at least one deposit from at least one of the first user or the second user associated with the transaction posting;
generating at least one ledger based on the transaction posting, the identification of the second user, the associated first user, and based on the timeline associated with the associated transaction posting; and wherein the at least one ledger is associated with the first user and the at least one second user; and wherein each ledger tracks the first transaction based on the timeline associated with the associated transaction posting;
allowing the at least one ledger to be presented to the first user and the one or more second users via one or more second graphical user interfaces;
determining whether the first user did not satisfy at least a portion of the timeline in at least one of the ledgers;
transferring at least a portion of at least one of the deposits to at least one of the second users if a determination is made that the first user did not satisfy the at least a portion of the timeline and if the at least one of the deposits is from the first user;
determining whether at least one of the second users did not satisfy at least a portion of the timeline in at least one of the ledgers; and
transferring at least a portion of at least one of the deposits to the first user if a determination is made that the at least one of the second users did not satisfy at least a portion of the timeline and if the at least one of the deposits is from the at least one second user.

19. The method of claim 18 further comprising:
receiving more than one transaction posting from the first user; and
receiving at least one timeline for each of the received transaction postings;
wherein at least one ledger is generated for each of the received transaction postings.

20. The method of claim 18 wherein the transaction comprises a real estate transaction.
